(19) United States
(12) Patent Application Publication
(10) Pub. No.: US 2012/0096003 A1
(43) Pub. Date: Apr. 19, 2012

(54) INFORMATION CLASSIFICATION DEVICE, INFORMATION CLASSIFICATION METHOD, AND INFORMATION CLASSIFICATION PROGRAM

(76) Inventors: Yousuke Motohashi, Tokyo (JP); Hidekazu Sakagami, Tokyo (JP); Tomohiro Isshiki, Tokyo (JP)

(21) Appl. No.: 13/378,637

(22) PCT Filed: May 12, 2010
(86) PCT No.: PCT/JP2010/003205

§ 371 Date: Dec. 15, 2011

(30) Foreign Application Priority Data
Jun. 29, 2009 (JP) 2009-154212

(51) Int. Cl. G06F 17/30

(52) U.S. Cl. 707/737; 707/E17.089

(57) ABSTRACT

It is an object of the present invention to provide an information classification device capable of classifying retrieved pieces of information into appropriate groups even if these pieces of information are the same kind of information. The information classification device according to the present invention includes spatial arrangement means and classification means. The spatial arrangement means performs processing for spatially arranging an information group of a first information type and an information group of a second information type based on relation between the information group of the first information type and the information group of the second information type. The classification means classifies the information group of the first information type based on the processing results of the spatial arrangement means.

### TECHNICAL FIELD

The present invention relates to an information classification device, an information classification method, and an information classification program for classifying retrieved pieces of information into appropriate groups.

### BACKGROUND ART

When information corresponding to a keyword (hereinafter referred to as a characteristic word) indicative of a certain characteristic is to be retrieved, a method of extracting and storing characteristic words beforehand from targeted documents, mails, or Web pages may be used. According to this method, when a user enters a characteristic word desired to search with, documents including the characteristic word can be extracted and displayed.

Further, there are known various methods capable of retrieving information without extracting characteristic words beforehand.

Patent Literature (PTL) 1 discloses a concept retrieval system making it easy for a searcher to extract documents in fields desired to extract. In the concept retrieval system described in PTL 1, stem vector preparation means divides fields in a dictionary preparation document group into plural parts to prepare a stem vector for each field. Then, targeted document vector preparation means uses the stem vector and a targeted document group to prepare a targeted document vector group for each field. When search text vector preparation means prepares a search text vector using search data and the stem vector based on field data, vector calculation means calculates a vector value using the search text vector and the targeted document vector group based on the field data.

Patent Literature (PTL) 2 discloses a document search device which expands search results and further extracts highly related documents. In the document search device described in PTL 2, a document classification part classifies documents as the search results into first sets of documents based on a citation index storing citation relations between documents. Then, a document expansion part searches for a second set of documents consisting of documents which are highly related to the documents included in the first sets of documents but are not included in the first sets of documents.

Patent Literature (PTL) 3 discloses a document classification device for classifying documents repeatedly in a short time with a high degree of efficiency so that the intention of an operator will be reflected. In the document classification device described in PTL 3, when an analysis part analyzes input document data, a vector generation part generates document feature vectors from the results. Then, when a conversion function calculation part calculates a representation space conversion function to project the document feature vectors into a space for reflecting similarities between the document feature vectors, a vector conversion part converts the document feature vectors using the function. Then, a classification part classifies the documents based on the similarities between the converted document feature vectors.

Patent Literature (PTL) 4 discloses a person introduction system capable of properly introducing persons who have knowledge about a specific field. When a combination of keywords, a document title, task ID, and the like is entered as search conditions, the person introduction system described in PTL 4 searches for related tasks and documents to extract creators of the documents and persons participating in the tasks in certain roles.

### Citation List

### Patent Literatures

PTL 1: Japanese Patent Application Publication No. 2004-86635 (Paragraph 0012)

PTL 2: Japanese Patent Application Publication No. 2007-328714 (Paragraphs 0010 and 0019)

PTL 3: Japanese Patent Application Publication No. 11-296552 (Paragraphs 0127 to 0129)

PTL 4: Japanese Patent Application Publication No. 2002-304536 (Paragraphs 0021 to 0024, and 0036 to 0039)

### SUMMARY OF INVENTION

### Technical Problem

When searches are performed with respect to characteristic words extracted from enormous volumes of documents, mails, and Web pages, there is a possibility that the extracted search results will be mammoth or it will take time to view the results. In this case, there is also a problem that users take a lot of trouble until the users find target information or the users may not be able to get optimum information. These problems can be solved to some extent by using the techniques described in PTL 1 to PTL 4.

However, in the concept retrieval system described in PTL 1, since searches are performed based on a vector group prepared for each field, documents prepared for different tasks or projects will be classified into the same group if they are in the same field. Thus, there is a problem that the concept retrieval system described in PTL 1 cannot extract information in the same field in certain unit such as the same task or related projects.

In the document search device described in PTL 2, documents having citation relations are classified into first sets of documents. However, in an actual task, since there are many documents having no citation relation, there is a problem that the document search device described in PTL 2 cannot group such documents.

In the document classification device described in PTL 3, document feature vectors are generated based on the word frequency in documents or the co-occurrence of words, and the documents are classified using the document feature vectors. However, words included in documents used in the same task or related projects and the co-occurrence of words on this occasion are often the same or similar. Thus, there is a problem that the document classification device described in PTL 3 cannot group the same kind of information including the same words into the same task or for each of related projects.

In the person introduction system described in PTL 4, documents corresponding to a specified keyword or the like can be extracted, but there is a problem that various kinds of information included in the extracted documents cannot be classified. This increases the burden on the user to view the extraction results.

Thus, even if the techniques described in PTL 1 to PTL 4 are used, the same kind of documents, such as documents used in related projects or tasks, cannot be classified properly.

Therefore, it is an object of the present invention to provide an information classification device, an information classification method, and an information classification program capable of classifying retrieved pieces of information into appropriate groups even if these pieces of information are the same kind of information.

### Solution to Problem

An information classification device according to the present invention is characterized by including spatial arrangement means for performing processing for spatially arranging an information group of a first information type and an information group of a second information type based on relation between the information group of the first information type and the information group of the second information type, and classification means for classifying the information group of the first information type based on the processing results of the spatial arrangement means.

An information classification method according to the present invention is characterized by performing processing for spatially arranging an information group of a first information type and an information group of a second information type based on relation between the information group of the first information type and the information group of the second information type, and classifying the information group of the first information type based on the processing results.

An information classification program according to the present invention is characterized by causing a computer to perform spatial arrangement processing for spatially arranging an information group of a first information type and an information group of a second information type based on relation between the information group of the first information type and the information group of the second information type, and classification processing for classifying the information group of the first information type based on the results of the spatial arrangement processing.

### ADVANTAGEOUS EFFECT OF INVENTION

According to the present invention, even if retrieved pieces of information are the same kind of information, these pieces of information can be classified into appropriate groups.

### BRIEF DESCRIPTION OF DRAWINGS

FIG. 1 is a block diagram showing one exemplary embodiment of an information classification device according to the present invention.

FIG. 2 is an explanatory diagram showing an example of information stored in an information storage section 161.

FIG. 3 is an explanatory diagram showing an example of relation between managed information stored in a relation storage section 162.

FIG. 4 is an explanatory diagram showing an example of information notified to a classification unit 130.

FIG. 5 is an explanatory diagram for explaining a case of arranging multiple pieces of information in space.

FIG. 6 is an explanatory diagram showing an arrangement of information at a weighted centroid.

FIG. 7 is an explanatory diagram showing an example in which a registration unit 140 registers information in the information storage section 161 and the relation storage section 162.

FIG. 8 is a flowchart showing the entire processing in the exemplary embodiment.

FIG. 9 is a flowchart showing an example of processing performed by a spatial arrangement calculating section 131.

FIG. 10 is a flowchart showing an example of processing performed by a representative information extracting section 133.

FIG. 11 is a flowchart showing an example of processing performed by a cluster label calculating section 134.

FIG. 12 is an explanatory diagram showing an example of a screen through which an I/O unit 150 accepts a search request.

FIG. 13 is an explanatory diagram showing another example of the screen through which the I/O unit 150 accepts a search request.

FIG. 14 is an explanatory diagram showing an example of the entire processing in Example 1.

FIG. 15 shows an example of a search results screen.

FIG. 16 is a block diagram showing the minimum configuration of the present invention.

### DESCRIPTION OF EMBODIMENT

An exemplary embodiment of the present invention will be described below with reference to the accompanying drawings.

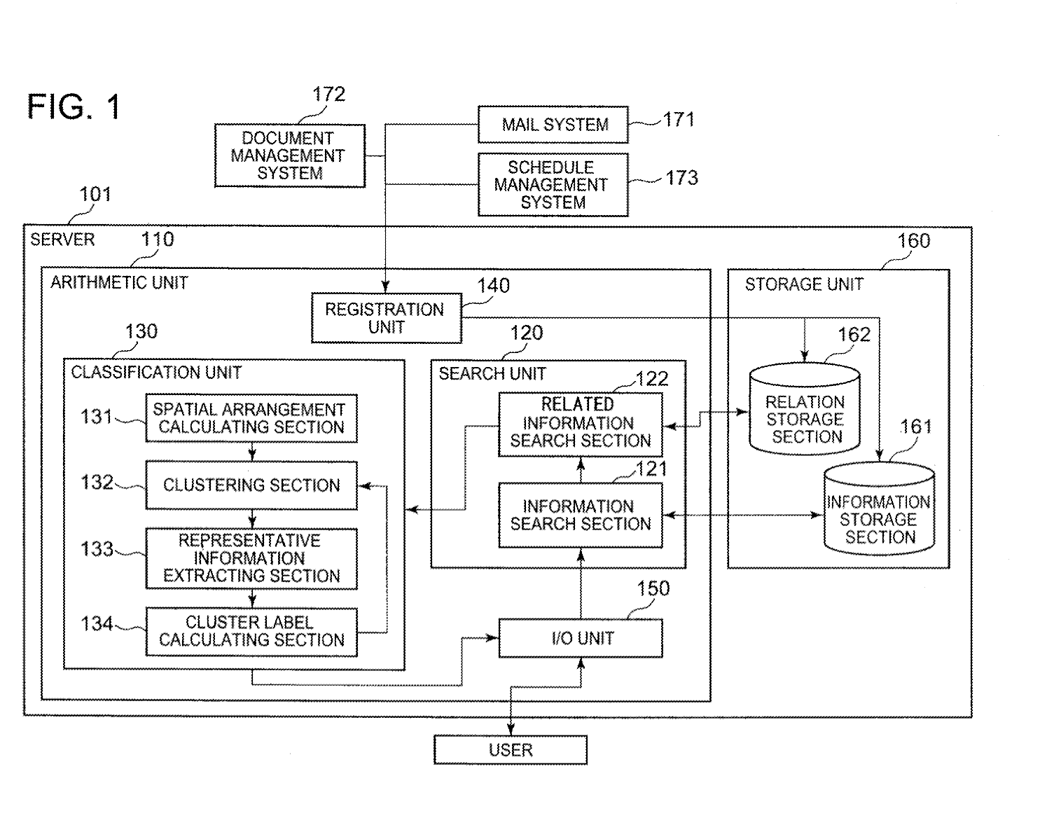

FIG. 1 is a block diagram showing one exemplary embodiment of an information classification device according to the present invention. The information classification device according to the exemplary embodiment includes a server 101. The server 101 is connected to a mail system 171, a document management system 172, a schedule management system 173, and the like, to receive documents (electronic documents), mails (e-mails), mail sending/receiving log data, and the like from these destinations. In other words, it can be said that the information classification device according to the present invention can work in cooperation with other systems, such as the mail system 171, the document management system 172, and the schedule management system 173.

Note that the mail system 171, the document management system 172, the schedule management system 173, and the like are not essential for the information classification device according to the present invention. For example, when documents, nails, mail sending/receiving log data, and the like are prestored in a storage unit (not shown) included in the server 101, the server 101 does not have to be connected to the mail system 171, the document management system 172, the schedule management system 173, and the like.

The server 101 includes an arithmetic unit 110 and a storage unit 160. The storage unit 160 includes an information storage section 161 and a relation storage section 162. The information storage section 161 stores the ID and title of information and the like to be managed (hereinafter referred to as managed information). For example, the information storage section 161 is realized by a magnetic disk drive or the like included in the storage unit 160. Here, managed information means all pieces of information to be managed in a system carrying out the present invention. The managed information includes information to be searched for (hereinafter referred to as targeted information), information related to the targeted information (hereinafter referred to as related information), and the like. The related information may be information different from information representing an attribute of the targeted information. Note that the targeted information and the related information are conceptual terms determined according to a search instruction, and it does not mean that the managed information belongs to either the targeted information or the related information. For example, the managed information is stored in a registration unit 140 to be described later or the information storage section 161 by the user.

Specifically, the information storage section 161 stores, as the managed information, at least either document files or screen information for displaying mails or Web pages (hereinafter referred to as Web page information). The information storage section 161 may also store, as the managed information, information indicative of persons, meetings, schedules, projects, tasks, organizations, tags, and books, images, videos, and the like. The following will describe a case where the information storage section 161 stores the managed information in association with an identifier (hereinafter referred to as “ID”) for identifying each piece of managed information and a name representing the content of the managed information.

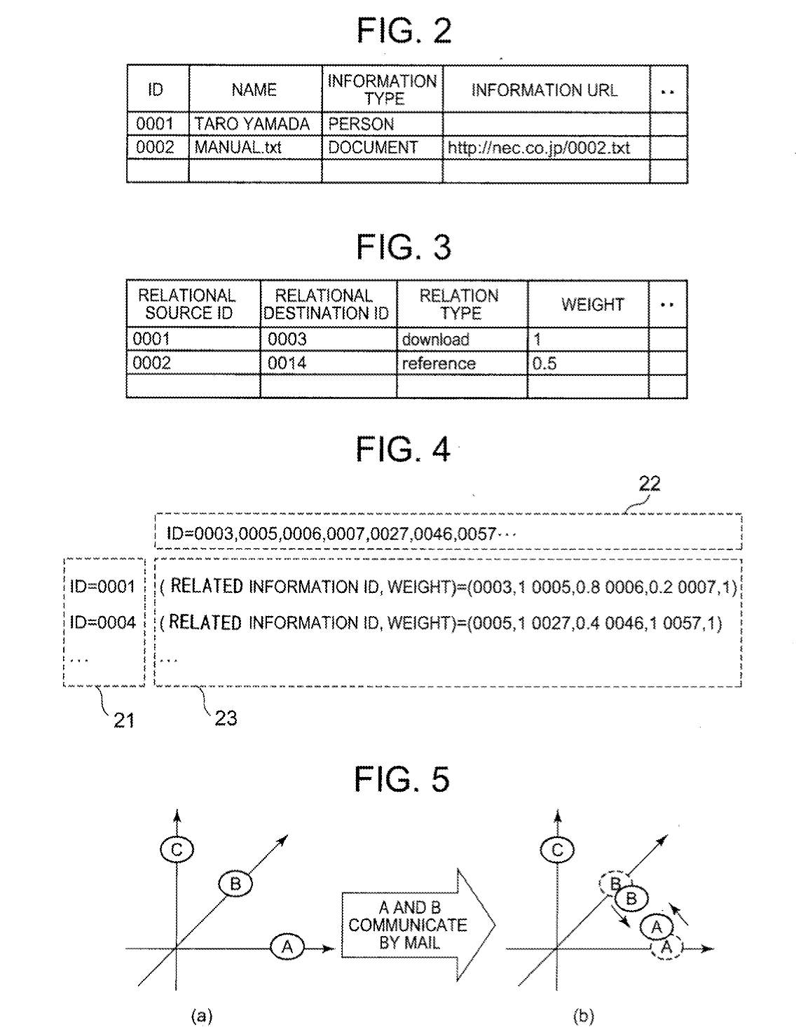

FIG. 2 is an explanatory diagram showing an example of information stored in the information storage section 161. In the example shown in FIG. 2, the information storage section 161 stores ID 201, name 202, information type 203, and information URL 204. The ID 201 is an identifier for identifying each piece of managed information. The name 202 is a name representing the content of the managed information. The information type 203 is predetermined information used to narrow down target information upon searching for the managed information or upon classification of the search results. The information URL 204 is information for specifying the location where the entity of the managed information exists.

The following will describe the case where the information storage section 161 stores the ID 201, the name 202, the information type 203, and the information URL 204, but the content the information storage section 161 stores is not limited to these pieces of information. For example, the information storage section 161 may also store each registrant, the date and time of registration, and the right of access, and the like. Further, the content of the information URL 204 may be left blank depending on the content of the information type 203.

The relation storage section 162 stores information indicative of relation between managed information. For example, the relation storage section 162 is realized by the magnetic disk drive or the like included in the storage unit 160. For example, the information indicative of relation between managed information is stored in the registration unit 140 to be described later or the relation storage section 162 by the user.

FIG. 3 is an explanatory diagram showing an example of information indicative of relation between managed information stored in the relation storage section 162. In the example shown in FIG. 3, the relation storage section 162 stores relational source information ID 301, relational destination information ID 302, relation type 303, and weight 304. The relational source information ID 301 and the relational destination information ID 302 are identifiers (i.e. IDs) for identifying respective pieces of managed information, indicating that there is some sort of relation between the managed information identified by the relational source information ID 301 and the managed information identified by the relational destination information ID 302.

The relation type 303 is information indicative of a type of relation between the managed information identified by the relational source information ID 301 and the managed information identified by the relational destination information ID 302. For example, the relation type 303 is used when only specific relation is extracted from relations between information or the like. The weight 304 is a value indicative of a degree of relation between the information identified by the relational source information ID 301 and the information identified by the relational destination information ID 302.

The following will describe the case where the relation storage section 162 store the relational source information ID 301, the relational destination information ID 302, the relation type 303, and the weight 304, but the content the relation storage section 162 stores is not limited to these pieces of information. For example, the relation storage section 162 nay also store associated person ID, the date and time of association, and the like.

The arithmetic unit 110 includes a search unit 120, a classification unit 130, a registration unit 140, and an I/O unit 150. The I/O unit 150 receives a search request input according to a user operation and notifies the search unit 120 of the search request. The I/O unit 150 may notify the search unit 120 of a search request received from a user terminal. The search request includes a keyword (hereinafter referred to as “search term”) used to narrow down targeted information, but the content included in the search request is not Limited to the search term. For example, the search request may also include a type (hereinafter referred to as “search information type”) for identifying information stored in the information storage section 161, the search results number, a condition (hereinafter referred to as “classification condition” or “classification standard” information) for specifying related information to classify targeted information, and the like. Based on the classification results received from the classification unit 130, the I/O unit 150 generates a display screen to be presented to the user, and outputs the display screen.

The search unit 120 includes an information search section 121 and a related information search section 122. The information search section 121 searches for managed information stored in the information storage section 161 based on the search term entered through the I/O unit 150 or the search information type. A search method used by the information search section 121 can be realized by any well-known search method. For example, the information search section 121 may search for managed information including the search term in the name 202 or managed information whose information type 203 matches the search information type. Further, if a URL is specified in the information URL 204, the information search section 121 may perform the above-mentioned search for managed information specified by the URL. In the following description, a managed information group searched for by the information search section 121 based on the search term or the search information type is referred to as a first information group.

The related information search section 122 searches the relation storage section 162 based on the search results (i.e., the first information group) received from the information search section 121 to retrieve managed information related to the first information group. Specifically, the related information search section 122 extracts, from the relation storage section 162, lines including “relational source IDs” or “relational destination IDs” that match IDs included in the first information group. Then, the related information search section 122 retrieves, from the information storage section 161, managed information identified by IDs corresponding to the matched “relational source IDs” or “relational destination IDs” (i.e., IDs corresponding to the “relational source IDs” are “relational destination IDs”, and IDs corresponding to the “relational destination IDs” are “relational source IDs”). In the following description, an information group retrieved by the related information search section 122 based on the first information group is referred to as a second information group.

The related information search section 122 generates information indicative of relation between the first information group and the second information group (hereinafter referred to as “relation information”). For example, the related information search section 122 may generate, as relation information, information in which weights are associated with the IDs of the first information group and the IDs of the second information group.

The related information search section 122 notifies the classification unit 130 of the first information group, the second information group, and the relation information together. When a classification condition is entered through the I/O unit 150, the classification condition is also notified together to the classification unit 130.

FIG. 4 is an explanatory diagram showing an example of information notified from the related information search section 122 to the classification unit 130. In the example shown in FIG. 4, the information search section 121 retrieves information including ID=0001, 0004, . . . as a first information group 21, and the related information search section 122 retrieves information including ID=0003, 0005, 0006, 0007, 0027, 0046, 0057, . . . as a second information group. Further, in the example shown in FIG. 4, the related information search section 122 generates relation information 23 indicating that ID=0001 in the first information group and ID=0003 in the second information group have a relation of weight 1. Since the same holds true for relations between the other IDs and weights, redundant description will be omitted.

Thus, on the whole, the search unit 120 has the function of searching for managed information based on the search term entered through the I/O unit 150 and notifying the classification unit 130 of the search results from the information search section 121 (i.e., the first information group) and the search results from the related information search section 122 (i.e., the second information group and the relation information) together.

In the following description, it is assumed that the first information group is managed information narrowed down by search information type “document” or “mail.” It is also assumed that the second information group is managed information narrowed down by classification condition “person.” In this case, the relation information is information indicative of relation between “document” or “mail” and “person.” Note that the search information type and the classification condition used to narrow down the first information group and the second information group are not limited to the above-mentioned contents. For example, the first information group may be managed information narrowed down by search information type “person” and the second information group may be managed information narrowed down by classification condition “document” or “mail.” Further, for example, the first information group may be managed information narrowed down by search information type “image” (“video” or the like). In addition, for example, the second information group may be managed information narrowed down by classification condition “project” or “event.”

In the following description, information included in the first information group narrowed down by the search information type may be referred to as a first kind of information, and information included in the second information group narrowed down by the classification condition may be referred to as a second kind of information.

The classification unit 130 includes a spatial arrangement calculating section 131, a clustering section 132, a representative information extracting section 133, and a cluster label calculating section 134.

The spatial arrangement calculating section 131 spatially arranges information included in the first information group and information included in the second information group based on the first information group, the second information group, and the relation information received from the related information search section 122. Here, the spatial arrangement means that all information is placed in a coordinate space according to relations with other information groups. In the following description, it is assumed that information is spatially arranged in such a manner that the distance between information becomes shorter as the degree of relation between information increases.

FIG. 5 is an explanatory diagram for explaining an example of arranging multiple pieces of information in space. In the example shown in FIG. 5, it is assumed that information to be spatially arranged is information A, B, and C. It is also assumed that respective pieces of independent information exist over independent dimensional axes, and the pieces of information A, B, and C are initially unrelated (independent) information and located at an equal distance along the respective dimensional axes. An example of this state is shown in FIG. 5(a).

Here, when there is any relation between information A and information B, the spatial arrangement calculating section 131 changes distances between information according to these relations to arrange all information in space. In the example shown in FIG. 5(b), it is assumed that information A and information B are of the type “person,” and information A and information B have relation to each other to perform mail communication. In this case, the spatial arrangement calculating section 131 determines that the two pieces of information have relation, and spatially arranges information A and information B in such a manner to move the position of information A in the direction of the dimensional axis of information B and the position of information B in the direction of the dimensional axis of information A (i.e., the distance between information A and information B is shortened).

The following will describe a case where the spatial arrangement calculating section 131 carries out an operation using a matrix to arrange each piece of information in space, but the method for the spatial arrangement calculating section 131 to arrange each piece of information in space is not limited to that using a matrix. For example, the spatial arrangement calculating section 131 may carry out an operation using vectors to arrange each piece of information in space.

The spatial arrangement calculating section 131 spatially arranges the first kind of information based on the relation information between the first kind of information and the second kind of information, and further the second kind of information based on the location of the spatially arranged information. The order of the spatial arrangements may be opposite. In other words, the spatial arrangement calculating section 131 may spatially arrange the second kind of information based on the relation information between the first kind of information and the second kind of information, and further the first kind of information based on the location of the spatially arranged information.

The following will describe a case where the spatial arrangement calculating section 131 first arranges the second kind of information (i.e., “person”) in space, and based on the location of the spatially arranged second kind of information, arranges the first kind of information (i.e., “document” or “mail”) in space. Note that the spatial arrangement calculating section 131 may first arrange the first kind of information (i.e., “document” or “mail”) in space, and based on the location of the spatially arranged first kind of information, arrange the second kind of information (i.e., “person”) in space.

The following will describe the operation of the spatial arrangement calculating section 131. The spatial arrangement calculating section 131 creates relation matrix A indicative of relation between the first information group and the second information group. For example, the spatial arrangement calculating section 131 creates relation matrix A based on conditions expressed in the following (Equation 1):

[Math. 1]

A(s,t)=1 (when there is relation between the t-th information in the first information group and the s-th information in the second information group), or

A(s,t)=0 (when there is no relation between the t-th information in the first information group and the s-th information in the second information group).
(Equation 1)

It can be said that the relation matrix A illustrated in (Equation 1) expresses the presence or absence of relation between information (i.e., relation information). In (Equation 1), each element of the relation matrix A is 1 or 0, but the spatial arrangement calculating section 131 may also replace this value by a weight read from the relation storage section 162 to crate relation matrix A.

Next, the spatial arrangement calculating section 131 creates relation matrix B indicative of relation between respective pieces of information in the second information group. For example, the spatial arrangement calculating section 131 creates relation matrix B based on the following (Equation 2):

[Math. 2]

B=D^{T}×C (Equation 2).

Here, matrix C is a matrix obtained by normalizing each row of the relation matrix A, and matrix D is a matrix obtained by normalizing each column of the relation matrix A. It is assumed that the normalization means that the sum of values in each row or each column is set to a fixed value, i.e., the sum is set to “1.” Specifically, the spatial arrangement calculating section 131 creates matrix C in such a manner that values in each row of the relation matrix A are added to obtain a value for each row, each value in the row concerned is divided by the value obtained, and the resulting value is assigned to each element in the matrix. Likewise, the spatial arrangement calculating section 131 creates matrix D in such a manner that values in each column of the relation matrix A are added to obtain a value, each value in the column concerned is divided by the value obtained, and the resulting value is assigned to each element in the matrix.

Creation of relation matrix B using (Equation 2) means that, when there is relation between pieces of information of the second kind, the distance between these pieces of information is shortened. In other words, creation of the relation matrix B means that the second kind of information is spatially arranged based on relation between the first kind of information and the second kind of information. Here, each row of the relation matrix B represents the space coordinates of each piece of information in the second information group. For example, a vector obtained by taking the first row from the relation matrix B represents the coordinates of the first information in the second information group.

Next, the spatial arrangement calculating section 131 creates relation matrix E indicative of relation between respective pieces of information in the first information group. For example, the spatial arrangement calculating section 131 creates relation matrix E based on the following (Equation 3):

[Math. 3]

E=C×B (Equation 3).

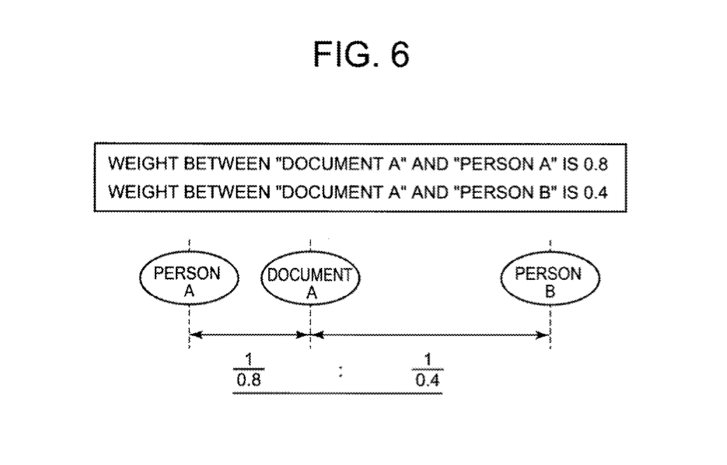

Creation of the relation matrix E using (Equation 3) means that each piece of information in the first information group is arranged at a weighted centroid of the coordinates at which the related second information group is arranged. FIG. 6 is an explanatory diagram showing an example of arranging the first kind of information at the weighted centroid of the second kind of information. In the example shown in FIG. 6, it is assumed that there is relation of a weight of “0.8” between “document A” and “person A,” and there is relation of a weight of “0.4” between “document A” and “person B.” In this case, “document A” is spatially arranged in a position obtained by internally dividing the distance between “person A” and “person B” at a ratio of 1/0.8:1/0.4.

If the coordinates of the arranged information A and B are expressed as Xa and Xb, respectively, and the weights (relation weights) between information C to be arranged and information A and B are expressed as Wac and Wbc, respectively, the coordinates Xc at which information C is arranged can be calculated by the following (Equation 4):

$$\begin{matrix}[ Math . 4 ] & \\ {X}_{c} = \frac{{X}_{a} \times {W}_{ac} + {X}_{b} \times {W}_{bc}}{{W}_{ac} + {W}_{bc}} . & ( Equation 4 )\end{matrix}$$

For example, when Xa=(2, 3) is set, Xb=(8, 9) is set, the weight Wac between information C and information A is set to 0.9, and the weight Wbc between information C and information B is set to 0.6, the coordinates Xc of information C is calculated as Xc=(4.4, 5.4) based on (Equation 4).

In (Equation 4), the coordinates of information to be arranged are calculated based on two pieces of information already arranged, but the number of pieces of information already arranged is not limited to two. The coordinates of information to be arranged can be calculated in the same manner with respect to three or more pieces of information.

Thus, it can be said that arrangement at a weighted centroid means that the first kind of information is arranged at an internally dividing point between the coordinates of the second kind of information based on the degree of relation (weight) between the first kind of information and the second kind of information. In other words, creation of such relation matrix E means that the first information group is arranged in space based on the coordinates of the spatially arranged second information group and the weight between the second information group and the first information group. Here, each row of the relation matrix E represents the space coordinates of each piece of information in the first information group. For example, a vector obtained by taking the first row from the relation matrix E represents the coordinates of the first information in the first information group.

The clustering section 132 groups respective pieces of spatially arranged information based on the degree of proximity of the information groups arranged by the spatial arrangement calculating section 131. In other words, since the spatial arrangement calculating section 131 spatially arranges pieces of information having a high degree of relation at a short distance, it can be said that grouping based on proximity means that the clustering section 132 groups pieces of information existing at short distances. The clustering section 132 groups respective pieces of information using a common nonhierarchical clustering technique such as k-means method. Note that the method of grouping information is not limited to the k-means method. For example, the clustering section 132 may group information using a hierarchical clustering technique or Ward's method as a specific method thereof. In the following description, grouping of respective pieces of spatially arranged information may be referred to as clustering. Further, each classified group may be referred to as a cluster.

Note that the k-means method is described in a document denoted by the following URL

“http://ibisforest.org/index.php?k-means%E6%B3%95,” the hierarchical clustering technique is described in a document denoted by the following URL
“http://gihyo.jp/dev/feature/01/visualization/0002,” and the Ward's method is described in a document denoted by the following URL “http://case.f7.ems.okayama-u.ac.jp/statedu/hbw2-book/node124.html,” respectively.

Here, a method of classifying each element using the k-means method will be described. At first, the clustering section 132 selects k elements at random from among elements. These elements are referred to as weeds. Since k clusters each of which includes each weed are created, the clustering section 132 classifies all the elements into a cluster including the nearest weed. The clustering section 132 calculates the centroid of elements in each cluster and the centroid is determined to be a new weed. The clustering section 132 recursively repeats the processing for classifying all elements into a cluster including the newly determined, nearest weed. The clustering section 132 completes the processing when the coordinates of weeds could not move more than a certain distance.

The representative information extracting section 133 extracts representative information in a cluster in which elements are grouped by the clustering section 132. For example, when representative information is determined from a first information group in the cluster, the representative information extracting section 133 determines representative information based on each piece of information in the first information group classified and relation with the second kind of information other than information to be classified. At this time, the representative information extracting section 133 may determine information having the highest relation with the second kind of information to be representative information. For example, the representative information extracting section 133 counts the number of pieces of information in each first information group (i.e., “document” or “mail”) in the cluster as having relation with the second kind of information (i.e., “person”) in the same cluster so that it may determine a first kind of information with the largest number of second kind of information to be representative information in the cluster. Likewise, when representative information is determined from a second information group in the cluster, the representative information extracting section 133 just has to determine representative information based on relation with the first kind of information. The representative information determined by the representative information extracting section 133 is, for example, notified to the I/O unit 150 and output to a display unit (not shown) or the like for displaying the classification results.

Thus, the representative information extracting section 133 extracts representative information in a cluster, and this can lighten the burden on the user to view the search results.

The cluster label calculating section 134 determines a word representing a feature of the cluster (hereinafter referred to as a label). For example, the cluster label calculating section 134 determines a word (i.e., a label) representing a feature of the first information group among information in the cluster. For example, the cluster label calculating section 134 determines a label of each cluster based on words or sentences (hereinafter referred to as content words) extracted from respective pieces of the first kind of information included in the cluster. Specifically, the cluster label calculating section 134 performs morphological analysis to extract content words from respective pieces of the first kind of information included in each cluster. Then, among the extracted content words, the cluster label calculating section 134 determines a characteristic content word representing the content of the cluster to be the label and gives the label to each cluster. The label determined by the cluster label calculating section 134 is, for example, notified to the I/O unit 150 and output to the display unit (not shown) or the like for displaying the classification results.

For example, the cluster label calculating section 134 may determine a characteristic word representing the content of the cluster using TF/IDF method for extracting a word seemed to be a characteristic word based on the frequency of appearance of each word existing in documents. Methods for morphological analysis are widely known. For example, any existing morphological analysis algorithm (e.g. “MeCab” or “ChaSen”) may be used, but the method for performing morphological analysis is not limited to these methods.

“ChaSen” mentioned above is described in a document denoted by the following URL “http://chasen-legacy.sourceforge.jp/,” “MeCab” is described in a document denoted by the following URL

“http://mecab.sourceforge.net,” and the TF/IDF method is described in a document denoted by the following URL
“http://ja.wikipedia.org/wiki/Tf-idf” or
“http://www.forest.dnj.ynu.ac.jp/˜ohmori/Paper/NL121/node6.html,” respectively.

Thus, the cluster label calculating section 134 determines a label in the cluster, and this enables the user to grasp a feature of the cluster at one view, thereby lightening the burden on the user to view the search results.

As mentioned above, it can be said that the classification unit 130 has the function of classifying the search results based on the search results (i.e., the first information group and the second information group) and the relation information received from the search unit 120.

The registration unit 140 stores information in the storage unit 160 (more specifically, the information Storage section 161 and the relation storage section 162) based on log data of the mail system 171 or the document management system 172. For example, when the log information is a mail transmission log, the registration unit 140 stores mail data and senders/receivers in the information storage section 161 according to predetermined rules, and relations between senders/receivers and mails in the relation storage section 162. For example, the registration unit 140 may receive log information and the like periodically sent from the mail system 171 or the document management system 172 to store, in the storage unit 160, information generated based on the information.

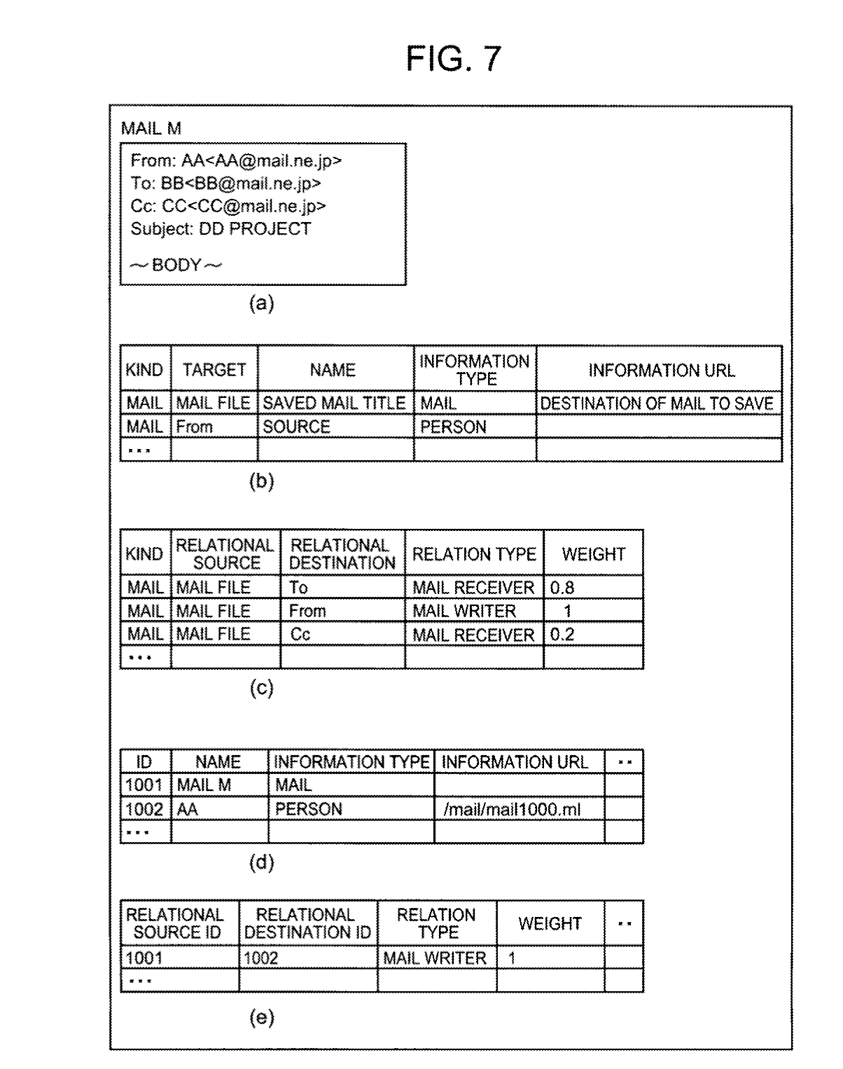

FIG. 7 is an explanatory diagram showing an example in which the registration unit 140 registers information in the information storage section 161 and the relation storage section 162. In the example shown in FIG. 7, it is assumed that a configuration information storage section (not shown) of the server 101 stores, as predetermined rules, rules illustrated in FIG. 7(b) and FIG. 7(c). For example, when the server 101 receives mail M illustrated in FIG. 7(a), the registration unit 140 stores, in the name 202, a mail name to be saved as, “mail” in the information type 203, and a destination of the mail in the information URL 204, respectively, based on the conditions illustrated in FIG. 7(b). The same holds true for the mail source. The results of storing these pieces of information are shown in FIG. 7(d).

Further, based on the conditions illustrated in FIG. 7(c), the registration unit 140 stores, in the relation storage section 162, relation between “mail file” and “From” as relation type “mail writer,” and a weight of “1.” The results of storing these pieces of information are shown in FIG. 7(e). Note that weights illustrated in FIG. 7(c) are, for example, values preset by the user based on relations between information. For example, when there is relation of “download” between two pieces of information, the weight may be preset to “1,” while when there is relation of “reference,” the weight may be preset to “0.5.” Setting the weights in this way enables the registration unit 140 to generate information illustrated in FIG. 3, for example.

The search unit 120 (more specifically, the information search section 121 and the related information search section 122), the classification unit 130 (more specifically, the spatial arrangement calculating section 131, the clustering section 132, the representative information extracting section 133, and the cluster label calculating section 134), the registration unit 140, and the I/O unit 150 are implemented by a CPU of a computer operating according to a program (information classification program). For example, the program is stored in a storage unit (not shown) of the server 101. The CPU may read the program and operates according to the program as the search unit 120 (more specifically, the information search section 121 and the related information search section 122), the classification unit 130 (more specifically, the spatial arrangement calculating section 131, the clustering section 132, the representative information extracting section 133, and the cluster label calculating section 134), the registration unit 140, and the I/O unit 150. Alternatively, the search unit 120 (more specifically, the information search section 121 and the related information search section 122), the classification unit 130 (more specifically, the spatial arrangement calculating section 131, the clustering section 132, the representative information extracting section 133, the cluster label calculating section 134), the registration unit 140, and the I/O unit 150 may be implemented in dedicated hardware, respectively.

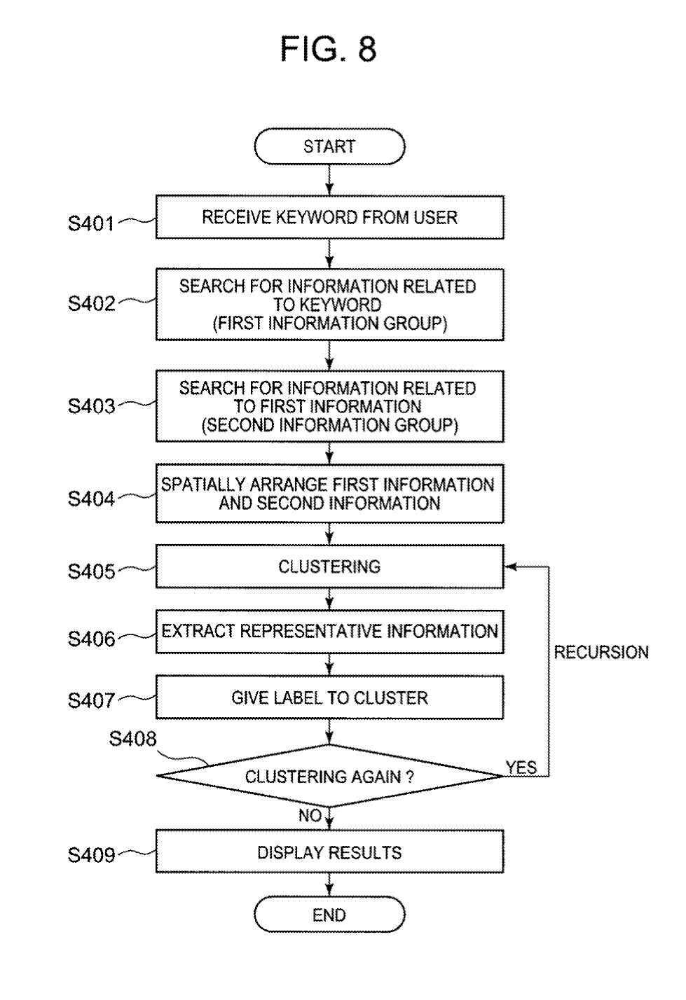

Next, the operation will be described. FIG. 8 is a flowchart showing an example of the entire processing in the exemplary embodiment. At first, when the I/O unit 150 receives a search term sent from a user terminal or a search term (keyword) entered in accordance with a user operation (step S401), the information search section 121 searches the information storage section 161 for managed information related to the search term (step S402). The search results are handled as a first information group. Next, the related information search section 122 searches for managed information related to respective pieces of information in the first information group (step S403). The search results are handled as a second information group. Further, the related information search section 122 generates relation information indicative of relation between the first information group and the second information group. When the spatial arrangement calculating section 131 arranges the first information group and the second information group in space (step S404), the clustering section 132 performs clustering based on the proximity of the results of the spatial arrangement (step S405). The representative information extracting section 133 extracts representative information (e.g. representative document) of the grouped information (i.e., cluster) (step S406), and the cluster label calculating section 134 gives a label to the cluster (step S407).

The cluster label calculating section 134 determines whether clustered groups is further grouped (step S408). For example, the cluster label calculating section 134 may determine that grouping is done until the number of documents included in each cluster becomes a certain number or less, or that grouping is done until the number of grouped hierarchical levels becomes a certain number or more.

If it is determined that grouping is done (YES in step S408), the clustering section 132, the representative information extracting section 133, and the cluster label calculating section 134 repeat processing from step S405 to step S407. In other words, such processing that the clustering section 132 performs clustering based on the spatial arrangement formed of clustered information (step S404), the representative information extracting section 133 extracts a representative document of each cluster, and the cluster label calculating section 134 gives a label to the cluster (step S407) is repeated. It can be said that this repetitive processing is recursive processing for making child clusters in a classified cluster to generate a hierarchical cluster structure. Thus, the cluster label calculating section 134 creates a hierarchical cluster structure to enable more refined classification, and this can lighten the burden on the user to view the results.

On the other hand, if it is determined that grouping is not done (NO in step S408), the I/O unit 150 generates, based on the classification results, information for displaying a display screen to be presented to the user, and outputs the information to a display unit (not shown) or the like (step S409).

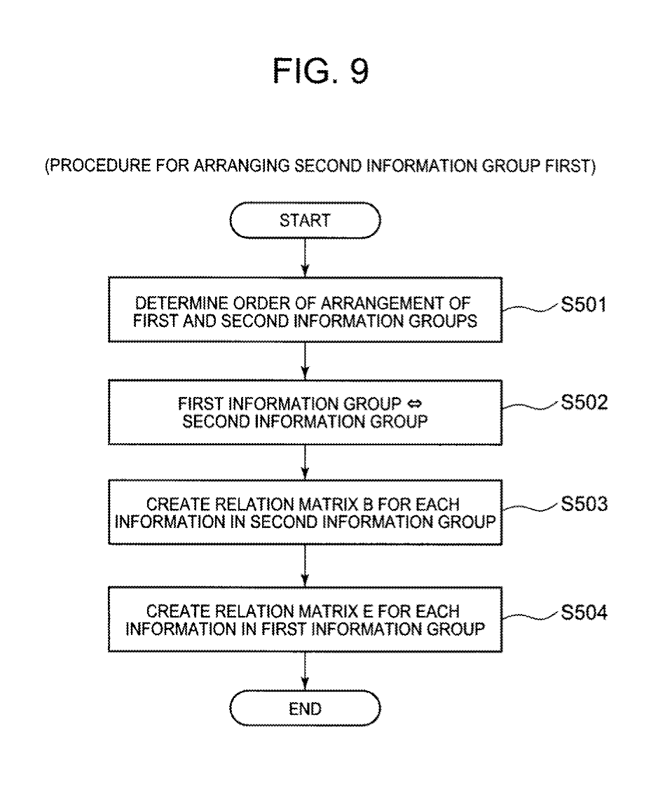

Next, the operation of the spatial arrangement calculating section 131 to arrange the first information group and the second information group in space will be described. FIG. 9 is a flowchart showing an example of processing performed by the spatial arrangement calculating section 131. At first, the spatial arrangement calculating section 131 determines which of the first information group and the second information group received from the search unit 120 is information to be arranged first (step S501). The information to be arranged first may be either the first information group or the second information group. However, it is more preferred that an information group with fewer pieces of information should be arranged first because an information group to be arranged later can be mapped more properly. The following will describe a case where the second information group is arranged first.

The spatial arrangement calculating section 131 creates relation matrix A indicative of relation between the first information group and the second information group (step S502). Then, the spatial arrangement calculating section 131 creates relation matrix B indicative of relation between respective pieces of information in the second information group (step S503). Finally, the spatial arrangement calculating section 131 creates relation matrix E indicative of relation between respective pieces of information in the first information group (step S504).

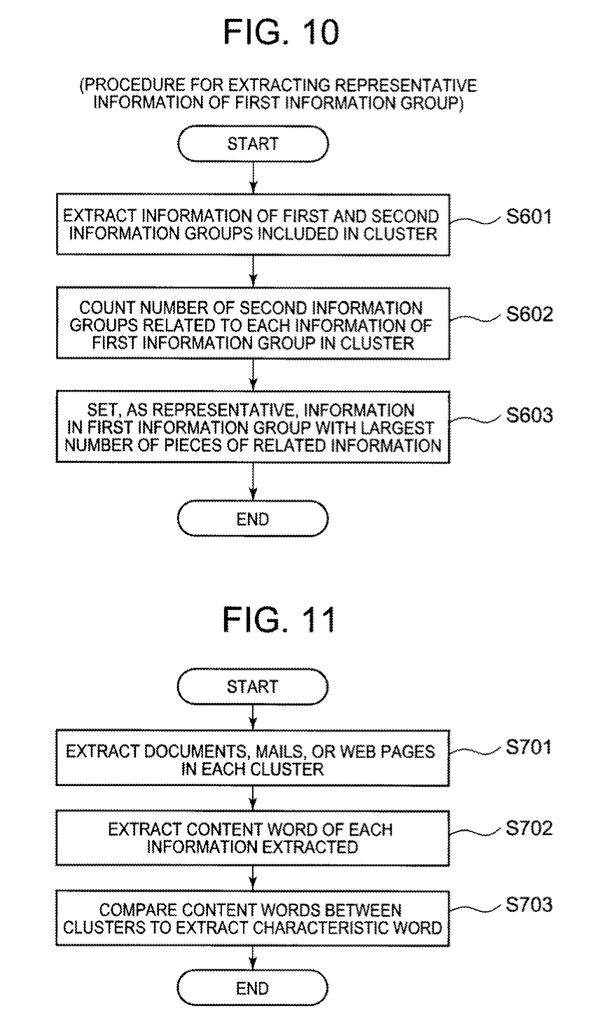

Next, the operation of the representative information extracting section 133 to extract representative information will be described. FIG. 10 is a flowchart showing an example of processing performed by the representative information extracting section 133. At first, the representative information extracting section 133 extracts a first kind of information and a second kind of information included in each cluster (step S601). Next, the representative information extracting section 133 counts, as being related to each piece of information of the first information group in each cluster, the number of second information groups in the same cluster (step S602). Then, the representative information extracting section 133 determines a first kind of information with the largest number to be representative information in the cluster (step S603).

Next, the operation of the cluster label calculating section 134 to determine a label will be described. FIG. 11 is a flowchart showing an example of processing performed by the cluster label calculating section 134. At first, the cluster label calculating section 134 extracts documents, mails, or Web page information included in each cluster (step S701). Next, the cluster label calculating section 134 performs morphological analysis or the like to extract content words of the extracted information (i.e., documents, mails, or Web page information) (step S702). Then, the cluster label calculating section 134 compares the extracted content words, respectively, to determine a characteristic content word (i.e., a label) of the cluster (step S703).

As described above, according to the present invention, the spatial arrangement calculating section 131 performs processing for spatially arranging the first kind of information group and the second kind of information group (for example, arranging them at weighted centroids) based on relation (e.g. weight) between the first kind of information group and the second kind of information group. Then, based on the processing results of the spatial arrangement calculating section 131, the clustering section 132 classifies the second kind of information group (or the first kind of information group). Therefore, even if retrieved pieces of information are the same kind of information, these pieces of information can be classified into appropriate groups.

In other words, as described in the exemplary embodiment, the spatial arrangement calculating section 131 performs processing for spatially arranging an information group “person” based on the relation between “document” or “mail” and “person,” and based on the processing results and the above relation, performs processing for spatially arranging an information group “document” or “mail.” Therefore, even if retrieved pieces of information are the same kind of information, these pieces of information can be classified into appropriate groups. Specifically, target documents can be classified properly for each related task or project. The results of such classification are presented to the user, and this can reduce the burden on the user to view the search results.

Further, according to the present invention, even when there are pieces of information that do not include any content word such as image or person, these pieces of information are spatially arranged based on relation with other information to classify target images or persons for each related task or project. Therefore, the results of such classification can also be presented to the user to lighten the burden on the user to view the search results.

For example, in the concept retrieval system described in PTL 1, although retrieved document vectors are created based on retrieved documents, since the retrieved document vectors cannot be created from image files, persons, and the like, these pieces of information cannot be classified. However, according to the present invention, even if pieces of information are obtained as a result of retrieving information including no content word such as image or person, these pieces of information can be classified on a related project or task basis.

Further, the spatial arrangement calculating section 131 may spatially arrange a second kind of information (or a first kind of information) based on relation between the first kind of information and the second kind of information different in content representing an attribute of the first kind of information. In this case, in addition to the above-mentioned effects, retrieved pieces of information can be classified into appropriate groups even if information used for classification is of a kind different in content representing an attribute of the retrieved information.

For example, it can be said that “person” is a kind of information different from the content representing an attribute of “document” or “mail.” However, according to the present invention, even in the case of such pieces of information, the pieces of information to be retrieved can be grouped properly.

In the exemplary embodiment, the description is made by using the relation between “person” and “document” or “mail.” This relation between the two kinds of information (i.e., “document” or “mail” and “person”) is considered to be effective in classifying respective pieces of information. Further, data on the relation between the two kinds of information is relatively accessible. Therefore, use of the two kinds of information as classification targets can lead to classifying respective pieces of information into appropriate groups.

Next, an alternative exemplary embodiment of the present invention will be described. In the aforementioned exemplary embodiment, the description is made on the case where the related information search section 122 generates two kinds of information groups and relation information between these information groups, the spatial arrangement calculating section 131 arranges one kind of information group in space and based on the spatial arrangement, arranges the other kind of information group in space. The alternative exemplary embodiment differs from the aforementioned exemplary embodiment in that the related information search section 122 generates three or more kinds of information groups and relation information among these information groups, and the spatial arrangement calculating section 131 arranges each kind of information group sequentially in space. The others are the same as those in the aforementioned exemplary embodiment.

The related information search section 122 searches the relation storage section 162 based on the search results (i.e., a first information group) received from the information search section 121 to retrieve managed information related to the first information group. This is referred to as a second information group. Then, the related information search section 122 generates relation information between the first information group and the second information group (referred to as first-second relation information).

Further, the related information search section 122 searches the relation storage section 162 based on the second information group to retrieve managed information related to the second information group. This is referred to as a third information group. Then, the related information search section 122 generates relation information between the second information group and the third information group (referred to as second-third relation information). Here, the related information search section 122 may generate relation information between the first information group and the third. information group (referred to as first-third relation information). The above-mentioned processing is repeated as many times as the number of pieces of related information used for classification.

Then, the related information search section 122 notifies the classification unit 130 of the retrieved multiple information groups (for example, the first information group, the second information group, and the third information group) and multiple pieces of relation information (for example, the first-second relation information and the second-third relation information) together.

The, spatial arrangement calculating section 131 spatially arranges information included in each information group based on the multiple information groups (for example, the first information group, the second information group, and the third information group) and the multiple pieces of relation information (for example, the first-second relation information and the second-third relation information) received from the related information search section 122. Specifically, the spatial arrangement calculating section 131 spatially arranges the first kind of information based on the relation information, and spatially arranges the second kind of information at a weighted centroid of the first kind of information arranged in space. Further, the spatial arrangement calculating section 131 spatially arranges information included in the third information group at a weighted centroid of the second kind of information arranged in space. Thus, the spatial arrangement calculating section 131 repeats processing for spatially arranging information in other information groups sequentially at weighted centroids of the information arranged in space. Note that the spatial arrangement calculating section 131 may arrange information in a multidimensional coordinate space, such as three-dimensional or four-dimensional coordinate space, depending on the number of kinds of information used.

Since the other configuration is the same as in the aforementioned exemplary embodiment, redundant description will be omitted.

As described above, according to the alternative exemplary embodiment, the spatial arrangement calculating section 131 performs processing for spatially arranging the first kind of information group based on relation between the first kind of information group and the second kind of information group. Further, the spatial arrangement calculating section 131 arranges any other kind of information group (for example, the third information group) based on the processing results and relation with the other kind of information group different from the first kind (for example, the third information group). Then, the clustering section 132 classifies the information group of the first information type based on the arrangement results of any other kind of information group (the third information group or another information group used for classification) different from the second type. Thus, even if three or more kinds of information are used, retrieved pieces of information can be classified.

### Example 1

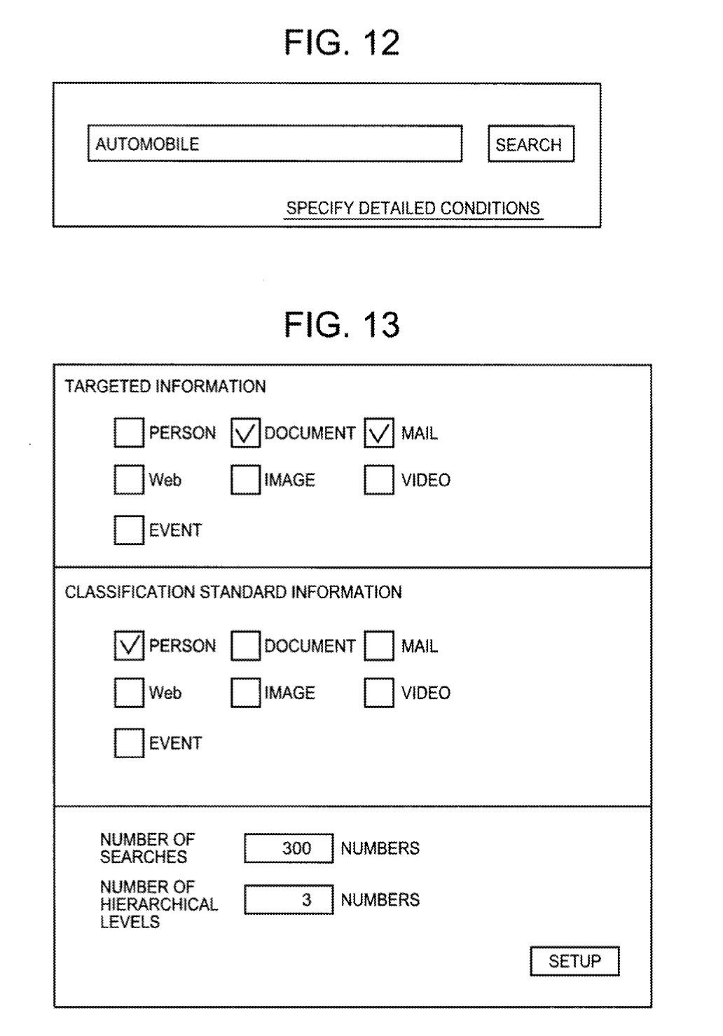

The following will describe specific examples of the present invention, but the scope of the present invention is not limited to the contents to be described below. FIG. 12 and FIG. 13 are explanatory diagrams showing an example of screens through which the I/O unit 150 accepts a search request. The user enters a search term and other detailed conditions on these screens. The detailed conditions may be preset. In this case, the user may not need to enter the detailed conditions. For example, if “person” is preselected as classification standard information on the screen illustrated in FIG. 13, preselected “person” may be set as the classification standard information unless any other classification standard information is particularly specified.

In the example shown in FIG. 12, it is shown that “automobile” is entered as a search term, and “document” and “mail” are selected as targeted information. It is also shown that “person” is preselected as the classification standard information. Further, the user can use the screen illustrated in FIG. 13 to set the kind of targeted information (first information group), the kind of information (second information group) used for classification, the number of searches, the presence or absence of hierarchical levels of clustering, and the like.

In Example 1, description will be made on a case where, when “mail” or “document” is specified as the first information group and “person” is specified as the second information group, respectively, the first information group (i.e., “mail” or “document”) is classified.

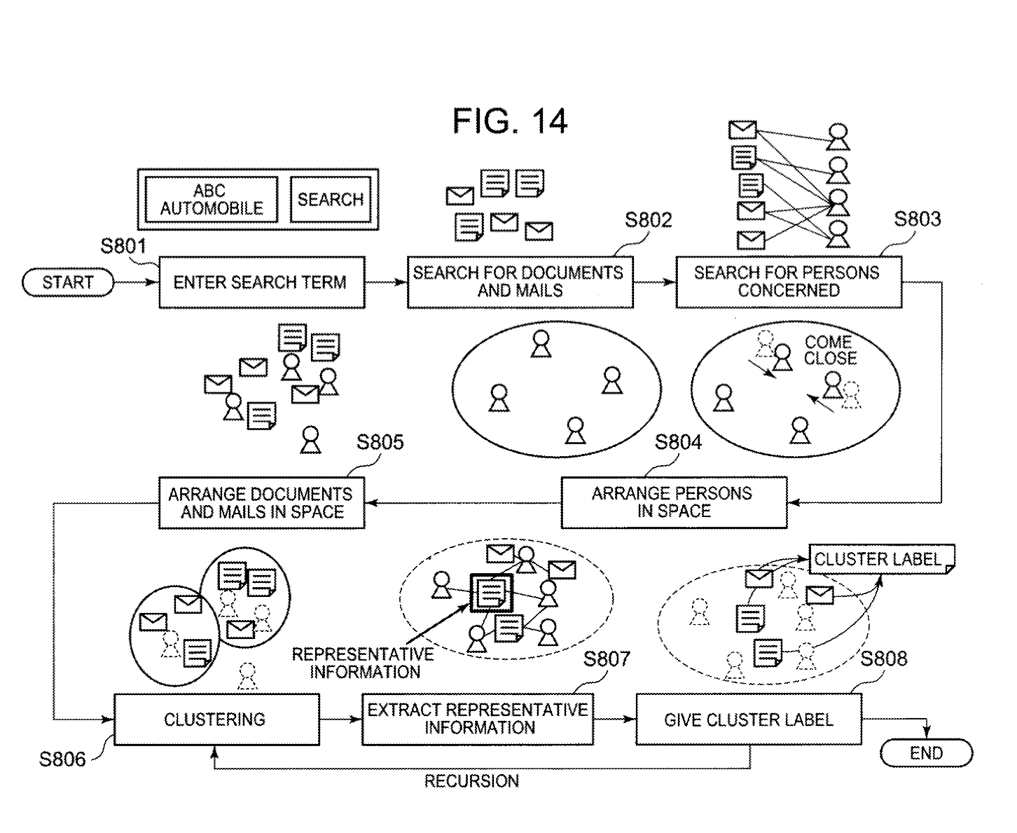

FIG. 14 is an explanatory diagram showing an example of the entire processing in Example 1. First, when the user enters a search term through the screens illustrated in FIG. 12 and FIG. 13 (step S801), the information search section 121 searches for “document” or “mail” related to the search term (step S802). Then, the related information search section 122 searches for “person” related to the search results of “document” or “mail” (step S803). Here, the spatial arrangement calculating section 131 creates a relation matrix from relation between “document” or “mail” and “person” to spatially arrange persons (step S804).

Further, the spatial arrangement calculating section 131 arranges “document” or “mail” based on the coordinates of “person” arranged in space (step S805). Then, the clustering section 132 performs clustering on “document” or “mail” arranged (step S806). After that, the representative information extracting section 133 extracts representative information of each cluster (step S807). The cluster label calculating section 134 determines a label for each cluster and gives the label to the cluster (step S809). Then, the I/O unit 150 generates a display screen to be presented to the user based on the representative information, characteristic words, information (including names, attributes, and the like) classified in each cluster, etc. received from the classification unit 130, and outputs the display screen.

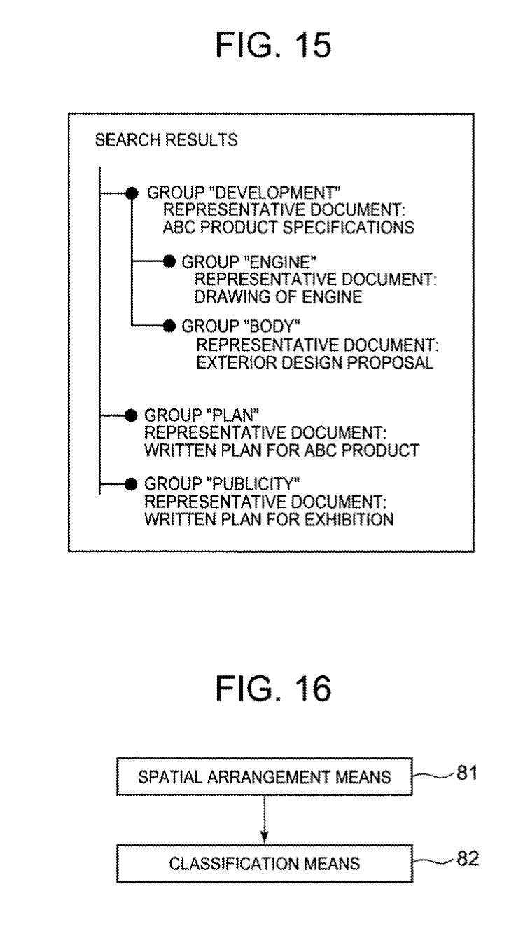

FIG. 15 is an explanatory diagram showing an example of a search results screen output by the I/O unit 150 in the example. As shown in the example of FIG. 15, the I/O unit 150 shows, on the search results screen, hierarchized clusters in a tree format or the like. Note that the display format of the search results screen is not limited to the tree format. For example, the I/O unit 150 may display the search results in a list format. At this time, the user can select a required cluster to get documents or mails included in the cluster.

In the example, the description is made on the case where “document” or “mail” is specified as the first information group. However, two or more kinds of information may be specified in the first information group, or only one kind of information, i.e., only “document” or only “mail,” may be specified.

### Example 2

Next, Example 2 will be described. In Example 1, the description is made on the case where the first information group (i.e., “document” or “mail”) is classified. In Example 2, description will be made on a case where, when “document” is specified as the first information group and “person” is specified as the second information group, respectively, the second information group (i.e., “person”) is classified.

At first, when a search term is entered, the information search section 121 searches for “document” related to the search term. Then, the related information search section 122 searches for “person” related to the search results of “document.” Here, the spatial arrangement calculating section 131 creates a relation matrix from relation between “document” and “person” to arrange “document” in space. Further, the spatial arrangement calculating section 131 arranges “person” based on the coordinates of “document” arranged in space. Then, the clustering section 132 performs clustering on “person” arranged.

Thus, according to Example 2, since documents are spatially arranged based on relation between information, and based on the results, persons are spatially arranged, target persons can be classified for each related task or project. The results of such classification can be presented to the user to lighten the burden on the user to view the search results.

### Example 3

Next, Example 3 will be described. In Example 1 and Example 2, the description is made on the case where two information groups are arranged in space. In Example 3, description will be made on a case where three information groups are arranged in space. Specifically, description will be made on a case where, when “document” is specified as the first information group, “mail” is specified as the second information group, and “person” is specified as the third information group, respectively, the first information group (i.e., “document”) is classified.

At first, when a search term is entered, the information search section 121 searches for “document” related to the search term. Then, the related information search section 122 searches for “mail” related to the search results of “document.” Further, the related information search section 122 searches for “person” related to the search results of “mail.” Here, the spatial arrangement calculating section 131 creates a relation matrix from relation between “person” and “mail” to arrange “person” in space. Next, the spatial arrangement calculating section 131 arranges “mail” based on the coordinates of “person” arranged in space. Further, the spatial arrangement calculating section 131 arranges “document” based on the coordinates of “mail” arranged in space. Then, the clustering section 132 performs clustering on “document” arranged. Thus, even if three information groups are used, clustering can be performed on targeted information.

### Example 4

Next, Example 4 will be described. In Example 4, description will be made on a case where four information groups are arranged in space. Specifically, description will be made on a case where, when “document” is specified. as the first information group, “mail” is specified as the second information group, “project” is specified as the third information group, and “person” is specified as a fourth information group, respectively, the first information group (i.e., “document”) is classified.

At first, when a search term is entered, the information search section 121 searches for “document” related to the search term. Then, the related information search section 122 searches for “mail” related to the search results of “document.” Next, the related information search section 122 searches for “project” related to the search results of “mail.” Further, the related information search section 122 searches for “person” related to the search results of “project.”

Here, the spatial arrangement calculating section 131 creates a relation matrix from relation between “person” and “project” to arrange “person” in space. Next, the spatial arrangement calculating section 131 arranges “project” based on the coordinates of “person” arranged in space. Further, the spatial arrangement calculating section 131 arranges “mail” based on the coordinates of “project” arranged in space. Finally, the spatial arrangement calculating section 131 arranges “document” based on the coordinates of “mail” arranged in space. Then, the clustering section 132 performs clustering on “document” arranged in space. Thus, even if three or more kinds (here, four kinds) of information are used, targeted information can be clustered.

### Example 5

Next, Example 5 will be described. Example 5 is the same as Example 3 in that three information groups are arranged in space, but different from Example 3 in that multiple kinds of information are included in each information group. Specifically, description will be made on a case where, when “document” or “mail” is specified as the first information group, “event” or “schedule” is specified as the second information group, and “person” is specified as the third information group, respectively, the first information group (i.e., “document” or “mail”) is classified.

At first, when a search term is entered, the information search section 121 searches for “document” or “mail” related to the search term. Then, the related information search section 122 searches for “event” or “schedule” related to the search results of “document” or “mail.” Further, the related information search section 122 searches for “person” related to the search results of “event” or “schedule.” Here, the spatial arrangement calculating section 131 creates a relation matrix from relation between “person” and “event” or “schedule” to arrange “person” in space. Next, the spatial arrangement calculating section 131 arranges “event” or “schedule” based on the coordinates of “person” arranged in space. Further, the spatial arrangement calculating section 131 arranges “document” or “mail” based on the coordinates of “event” or “schedule” arranged in space. Then, the clustering section 132 performs clustering on “document” or “mail” arranged. Thus, even if two or more kinds of information are used in each information group, targeted information can be clustered.

### Example 6

Next, Example 6 will be described. Example 6 is the same as Example 3 and Example 5 in that three information groups are arranged in space, but different from Example 3 and Example 5 in that there is any information group including no content word in the information groups. Specifically, description will be made on a case where, when “document” is specified as the first information group, “video” is specified as the second information group, and “performer” is specified as the third information group, the second information group (i.e., “video”) is classified.

At first, when a search term is entered, the information search section 121 searches for “document” related to the search term. Then, the related information search section 122 searches for “video” related to the search results of “document.” Further, the related information search section 122 searches for “performer” related to the search results of “document.” Here, the spatial arrangement calculating section 131 creates a relation matrix from relation between “document” and “performer” to arrange “performer” in space. Next, the spatial arrangement calculating section 131 arranges “document” based on the coordinates of “performer” arranged in space. Further, the spatial arrangement calculating section 131 arranges “video” based on the coordinates of “document” arranged in space. Then, the clustering section 132 performs clustering on “video” arranged. Thus, even if two or more kinds of information are used in each information group, targeted information can be clustered.

Note that any other relation information may be used to perform clustering on “video.” At first, when “video” is specified as targeted information, the information search section 121 searches managed information for “video.” Then, the related information search section 122 searches for “document” related to the search results of “video.” Further, the related information search section 122 searches for “performer” related to the search results of “document.” Here, the spatial arrangement calculating section 131 creates a relation matrix between “performer” and “document” to arrange “performer” in space. Next, the spatial arrangement calculating section 131 arranges “document” based on the coordinates of “performer” arranged in space. Further, the spatial arrangement calculating section 131 arranges “video” based on the coordinates of “document” arranged in space. Then, the clustering section 132 performs clustering on “video” arranged. Thus, in the example, clustering can be performed even on information including no content word.

While the present invention is described using the specific examples, the present invention can also be applied to the search functions of various systems as follows: For example, examples of the systems to which the present invention can be applied include a Web search system, groupware, a document sharing system, a content management system, and a schedule management system, but the systems to which the present invention can be applied are not limited to these systems. As other systems, there are a task management system and a web log system.

Next, the minimum configuration of the present invention will be described. FIG. 16 is a block diagram showing the minimum configuration of the present invention. The information classification device according to the present invention includes spatial arrangement means 81 (e.g. the spatial arrangement calculating section 131) for spatially arranging an information group of a first information type and an information group of a second information type based on relation (e.g. relation information or a weight) between the information group of the first information type (e.g., the first kind of information) and the information group of the second information type (e.g. the second kind of information), and classification means 82 (e.g. the clustering section 132) for classifying the information group of the first information type based on the processing results of the spatial arrangement means 81.

According to such a configuration, even if retrieved pieces of information are the same kind of information, these pieces of information can be classified into appropriate groups.

It can also be said that at least the following information classification devices are described in any of the aforementioned exemplary embodiments and examples:
(1) An information classification device including spatial arrangement means (e.g. the spatial arrangement calculating section 131) for spatially arranging an information group of a first Information type and an information group of a second information type based on relation (e.g. relation information or a weight) between the information group of the first information type (e.g. the first kind of information) and the information group of the second information type (e.g. the second kind of information), and classification means (e.g. the clustering section 132) for classifying the information group of the first information type based on the processing results of the spatial arrangement means.
(2) The information classification device wherein the spatial arrangement means performs processing for spatially arranging the information group of the second information type based on relation between the information group of the first information type (e.g. “document” or “mail”) and the information group of the second information type (e.g. “person”), and based on the processing results and the relation, performs processing for spatially arranging the information group of the first information type.
(3) The information classification device wherein the spatial arrangement means performs processing (e.g., processing for creating relation matrix B and relation matrix E) for making a spatial arrangement in such a manner to shorten the distance (e.g., distance in a coordinate space) as a weight indicative of a degree of relation between information of the first information type and information of the second information type increases.
(4) The information classification device wherein the spatial arrangement means performs processing for spatially arranging the information group of the first information type and the information group of the second information type based on relation between the information group of the first information type and the information group of the second information type (e.g. “person”) as information different in content representing an attribute of information (e.g. “document” or “mail”) of the first information type.
(5) The information classification device further including representative information determining means (e.g. the representative information extracting section 133) for determining representative information as a representative of a group from among the group of information classified by the classification means, wherein the representative information determining means determines representative information based on relation (e.g. the number of related pieces of information) between each piece of information to be classified and information other than the information to be classified.
(6) The information classification device further including characteristic word determining means (e.g. the cluster label calculating section 134) for determining a word (e.g. label) indicative of a feature for each group of information classified by the classification means, wherein the characteristic word determining means determines a word indicative of a feature in the group based on words extracted from respective pieces of information included in the group.
(7) The information classification device wherein the spatial arrangement means performs processing for spatially arranging person information based on relation between a document or mail and the person information, and performs processing for spatially arranging the document or mail based on the spatial arrangement of the person information and the relation, and the classification means classifies the document or mail based on the spatial arrangement of the document or mail.
(8) The information classification device wherein the spatial arrangement means performs processing for spatially arranging a document or mail based on relation between person information and the document or mail, and performs processing for spatially arranging the person information based on the spatial arrangement of the document and mail and the relation, and the classification means classifies the person information based on the spatial arrangement of the person information.
(9) The information classification device wherein the spatial arrangement means performs processing for spatially arranging person information based on relation between an image and the person information, and performs processing for spatially arranging the image based on the spatial arrangement of the person information and the relation, and the classification means classifies the image based on the spatial arrangement of the image.
(10) The information classification device wherein the spatial arrangement means performs processing for spatially arranging an image based on relation between person information and the image, and performs processing for spatially arranging the person information based on the spatial arrangement of the image and the relation, and the classification means classifies the person information based on the spatial arrangement of the personal information.
(11) The information classification device wherein the spatial arrangement means performs processing for spatially arranging a project or event based on relation between a document or mail and the project or event, and performs processing for spatially arranging the document or mail based on the spatial arrangement of the project or event and the relation, and the classification means classifies the document or mail based on the spatial arrangement of the document or mail.
(12) The information classification device wherein the spatial arrangement means performs processing for spatially arranging a document or mail based on relation between a project or event and the document or mail, and performs processing for spatially arranging the project or event based on the spatial arrangement of the document or mail and the relation, and the classification means classifies the project or event based on the spatial arrangement of the project or event.
(13) The information classification device wherein the spatial arrangement means performs processing for spatially arranging an information group of a second information type based on relation between an information group of a first information type and the information group of the second information type, and based on the processing results and relation with an information group of any other information type (e.g., a third information group) different from the first information type, performs processing for spatially arranging the information group of the other information type (e.g. the third information group), and the classification means classifies the information group of the first information type based on the results of arrangement of an information group of any other information type (the third information group or any other information group used for classification) different from the second information type.

As described above, although the present invention is described with reference to the exemplary embodiments and examples, the present invention is not limited to the aforementioned exemplary embodiments and examples. Various changes that can be understood by those skilled in the art within the scope of the present invention can be made to the configurations and details of the present invention.

This application claims priority from Japanese Patent Application No. 2009-154212, filed on Jun. 29, 2009, the entire disclosure of which is incorporated herein by reference.

### INDUSTRIAL APPLICABILITY

The present invention can be suitably applied to an information classification device for classifying retrieved pieces of information into appropriate groups.

### REFERENCE SIGNS LIST

101 Server

110 Arithmetic Unit

120 Search Unit

121 Information Search Section

122 Related Information Search Section

130 Classification Unit

131 Spatial Arrangement Calculating Section

132 Clustering Section

133 Representative Information Extracting Section

134 Cluster Label Calculating Section

140 Registration Unit

150 I/O Unit

160 Storage Unit

161 Information Storage Section

162 Relation Storage Section

171 Mail System

172 Document Management System

173 Schedule Management System

1-19. (canceled)

20. An information classification device characterized by comprising:
spatial arrangement unit which performs processing for spatially arranging an information group of a first information type and an information group of a second information type based on relation between the information group of the first information type and the information group of the second information type; and
classification unit which classifies the information group of the first information type based on the processing results of the spatial arrangement unit.

21. The information classification device according to claim 20, wherein the spatial arrangement unit performs processing for spatially arranging the information group of the second information type based on the relation between the information group of the first information type and the information group of the second information type, and based on the processing results and the relation, performs processing for spatially arranging the information group of the first information type.

22. The information classification device according to claim 20, wherein the spatial arrangement unit performs processing for making a spatial arrangement in such a manner to shorten distance as a weight indicative of a degree of relation between information of the first information type and information of the second information type increases.

23. The information classification device according to claim 20, wherein the spatial arrangement unit performs processing for spatially arranging the information group of the first information type and the information group of the second information type based on relation between the information group of the first information type and the information group of the second information type as information different in content representing an attribute of information of the first information type.

24. The information classification device according to claim 20, further comprising
representative information determining unit which determines representative information as a representative of a group from among the group of information classified by the classification unit,
wherein the representative information determining unit determines representative information based on relation between each piece of information to be classified and information other than the information to be classified.

25. The information classification device according to claim 20, further comprising
characteristic word determining unit which determines a word indicative of a feature for each group of information classified by the classification unit,
wherein the characteristic word determining unit determines a word indicative of a feature in the group based on words extracted from respective pieces of information included in the group.

26. The information classification device according to claim 20, wherein
the spatial arrangement unit performs processing for spatially arranging person information based on relation between a document or mail and the person information, and performs processing for spatially arranging the document or mail based on the spatial arrangement of the person information and the relation, and
the classification unit classifies the document or mail based on the spatial arrangement of the document or mail.

27. The information classification device according to claim 20, wherein
the spatial arrangement unit performs processing for spatially arranging a document or mail based on relation between person information and the document or mail, and performs processing for spatially arranging the person information based on the spatial arrangement of the document and mail and the relation, and
the classification unit classifies the person information based on the spatial arrangement of the person information.

28. The information classification device according to claim 20, wherein
the spatial arrangement unit performs processing for spatially arranging person information based on relation between an image and the person information, and performs processing for spatially arranging the image based on the spatial arrangement of the person information and the relation, and
the classification unit classifies the image based on the spatial arrangement of the image.

29. The information classification device according to claim 20, wherein
the spatial arrangement unit performs processing for spatially arranging an image based on relation between person information and the image, and performs processing for spatially arranging the person information based on the spatial arrangement of the image and the relation, and
the classification unit classifies the person information based on the spatial arrangement of the personal information.

30. The information classification device according to claim 20, wherein
the spatial arrangement unit performs processing for spatially arranging a project or event based on relation between a document or mail and the project or event, and performs processing for spatially arranging the document or mail based on the spatial arrangement of the project or event and the relation, and
the classification unit classifies the document or mail based on the spatial arrangement of the document or mail.

31. The information classification device according to claim 20, wherein
the spatial arrangement unit performs processing for spatially arranging a document or mail based on relation between a project or event and the document or mail, and performs processing for spatially arranging the project or event based on the spatial arrangement of the document or mail and the relation, and
the classification unit classifies the project or event based on the spatial arrangement of the project or event.

32. The information classification device according to claim 20, wherein
the spatial arrangement unit performs processing for spatially arranging the information group of the second information type based on the relation between the information group of the first information type and the information group of the second information type, and based on the processing results and relation with an information group of any other information type different from the first information type, performs processing for spatially arranging the information group of the other information type, and
the classification unit classifies the information group of the first information type based on the results of arrangement of an information group of any other information type different from the second information type.

33. An information classification method characterized by comprising:
performing processing for spatially arranging an information group of a first information type and an information group of a second information type based on relation between the information group of the first information type and the information group of the second information type, and
classifying the information group of the first information type based on the processing results.

34. The information classification method according to claim 33, wherein processing for spatially arranging the information group of the second information type based on the relation between the information group of the first information type and the information group of the second information type is performed, and based on the processing results and the relation, processing for spatially arranging the information group of the first information type is performed.

35. The information classification method according to claim 33, wherein
processing for spatially arranging the information group of the second information type based on the relation between the information group of the first information type and the information group of the second information type is performed,
an information group of any other information type is arranged based on the processing results and relation with the information group of the other information type different from the first information type, and
the information group of the first information type is classified based on the results of arrangement of the information group of any other information type different from the second information type.

36. An information classification program which, when executed by a processor, performs a method for
spatial arrangement processing for spatially arranging an information group of a first information type and an information group of a second information type based on relation between the information group of the first information type and the information group of the second information type, and
classification processing for classifying the information group of the first information type based on the results of the spatial arrangement processing.

37. The information classification program according to claim 36, the program further comprising
in the spatial arrangement processing, processing for spatially arranging the information group of the second information type based on the relation between the information group of the first information type and the information group of the second information type, and based on the processing results and the relation, processing for spatially arranging the information group of the first information type.

38. The information classification program according to claim 36, the program further comprising
in the spatial arrangement processing, processing for spatially arranging the information group of the second information type based on the relation between the information group of the first information type and the information group of the second information type, and based on the processing results and relation with an information group of any other information type different from the first information type, arranging the information group of the other information type, and
in the classification processing, classifying the information group of the first information type based on arrangement results of an information group of any other information type different from the second information type.
